(19) United States
(12) Patent Application Publication
(10) Pub. No.: US 2005/0248649 A1
(43) Pub. Date: Nov. 10, 2005

(54) Direct-print sublimation ink support substrates and related methods of producing printed sublimation fabrics and/or sublimating a decoration onto target products

(76) Inventors: Clarence Wayne Farrell, Gibsonville, NC (US); Robert W. Powell, Burlington, NC (US); Dhaval H. Amin, Burlington, NC (US)

Correspondence Address: MYERS BIGEL SIBLEY & SAJOVEC, PO BOX 37428, RALEIGH, NC, 27627, US

(21) Appl. No.: 11/113,850

(22) Filed: Apr. 25, 2005

Related U.S. Application Data
(60) Provisional application No. 60/565,465, filed on Apr. 26, 2004.

(51) Int. Cl. B41J 2/325

(52) U.S. Cl. 347/216

(57) ABSTRACT

Direct-print sublimation ink transfer substrates are described as well as related methods and apparatus that employ and/or generate direct-print ink substrates for sublimation.

### RELATED APPLICATIONS

This application claims priority to U.S. Provisional Application Ser. No. 60/565,465, filed Apr. 26, 2004, the contents of which are hereby incorporated by reference as if recited in full herein.

### FIELD OF THE INVENTION

The present invention relates to sublimation printing.

### BACKGROUND OF THE INVENTION

Generally stated, sublimation is a type of ink and/or dye printing that employs heat and pressure to transfer a decoration held on a sublimation-ink support sheet (also known as a transfer or carrier sheet) onto a target product. In the past, various devices have been proposed to carry out the transfer so as to accommodate different object configurations as well as to attempt to improve image reproduction and/or color on the object. Conventionally, an indirect two-step ink support printing process has been used. For example, a target decoration is printed onto a first ink transfer paper, the mirror image of the decoration is transferred to a second ink transfer fabric sheet, then the mirror image of the second sheet decoration is resublimated onto the target product. Unfortunately, the fabric used in the two-step process can unduly shrink causing the sublimation image to be smaller than desired and/or the transferred color may have reduced intensity.

### SUMMARY OF EMBODIMENTS OF THE INVENTION

Embodiments of the present invention provide direct-print ink transfer substrates and methods and apparatus that employ and/or generate the direct-print ink support substrates for sublimation.

The direct-print substrate can be a textile fabric material. In particular embodiments, the direct-print ink support substrates can be a stretch-fabric. The stretch-fabric can be an elastic material having a thickness of less than about 3 mm, typically about 1 mm or less. In some embodiments the stretch fabric may have a thickness between about 4-12 microns. The stretch-fabric may be configured to have a desired absorbency capacity. The stretch-fabric may comprise a knit or woven fabric. In some embodiments, the stretch fabric comprises RAYON® and/or nylon and/or cotton and/or wool.

Certain embodiments are directed to methods of fabricating a direct-print ink support sublimation substrate, comprising: (a) releasably attaching a selected ink support material to a backing material; (b) directly printing a sublimation image onto the ink support material (the image printed a mirror image of the desired end-sublimation image); then (c) separating the ink support material from the backing material to thereby provide a direct-print sublimation image for transfer to a target object during sublimation.

Other embodiments are directed to methods for sublimation printing a target object. The methods include: (a) placing a direct-print ink transfer substrate with a mirror image of the desired end sublimation image imprinted thereon over a target object so that the ink transfer substrate is in intimate contact therewith and so that the sublimation image contacts the object; and (b) sublimating the target object to thereby transfer the sublimation image on the direct-print ink transfer substrate to the target object.

Still other embodiments are directed to apparatus for directly printing a sublimation image on a direct-print ink transfer substrate. The apparatus includes: (a) an offset printer configured to print a mirror image of an end sublimation image onto an ink support substrate; and (b) a controller in communication with the printer.

In certain embodiments, the controller comprises computer program code configured to automatically direct the printer to output a plurality of different colors in a predetermined amount and pattern to generate a color image in a mirror image of a selected one of a library of end sublimation images.

Yet other embodiments are directed to direct-print ink support sublimation substrates comprising a thin elastic fabric having a direct-print sublimation mirror image representation of a desired end sublimation image thereon. The direct-print ink sublimation image can be substantially the same size as the sublimation image (having reduced shrinkage over conventional two-step fabrics). The direct-print ink sublimation fabric can also hold increased ink relative to the two-step fabric.

The direct-print ink support may be releasably attached to a backing material.

Embodiments, features and/or operations of the invention may include or be carried out via hardware, software or combinations of same. The foregoing and other objects and aspects of the present invention are explained in detail herein.

### BRIEF DESCRIPTION OF THE DRAWINGS

FIG. 1 is a top perspective view of a direct-print ink transfer substrate having a sublimation image thereon held on a backing substrate according to embodiments of the present invention.

FIGS. 2A-2D are schematic illustrations of a series of operations that can be used to carry out embodiments of the present invention.

FIG. 3A is a top perspective view of an alternative backing substrate configuration according to embodiments of the present invention.

FIG. 3B is an exploded view of a direct-print ink transfer substrate with the backing substrate shown in FIG. 3A according to other embodiments of the present invention.

FIG. 4A is a schematic illustration of a system for direct printing onto an ink transfer substrate according to embodiments of the present invention.

FIG. 4B is a schematic illustration of a system for direct printing onto an ink transfer substrate according to other embodiments of the present invention.

FIG. 5A is a front perspective view of an exemplary pressure vessel sublimation apparatus according to embodiments of the present invention.

FIG. 5B is a front perspective view of the apparatus shown in FIG. 5A illustrated with the chamber opened according to embodiments of the present invention.

FIG. 5C is a front perspective view of an exemplary pressure vessel sublimation apparatus with a direct-print ink transfer substrate according to embodiments of the present invention.

FIG. 6 illustrates a sublimation transfer of the decoration from the ink transfer substrate to the target object shown in FIG. 5C when the pressure vessel is opened.

FIG. 7 is a side sectional view of an exemplary 3-D sublimated product according to embodiments of the present invention.

FIG. 8 is a side sectional view of another exemplary 3-D sublimated product according to embodiments of the present invention.

FIG. 9 is a schematic illustration of a sublimation system according to embodiments of the present invention.

FIG. 10A is a partial section view of a pressure vessel similar to that shown in FIG. 9.

FIG. 10B illustrates the pressure vessel shown in FIG. 10A with the target object placed on a platform to raise it a distance above the floor according to embodiments of the present invention.

FIG. 11A is a schematic illustration of another embodiment of a pressure system according to embodiments of the present invention.

FIG. 11B is a perspective view of a floor suitable for use with the pressure vessel shown in FIG. 11A.

FIG. 12 is a schematic illustration of another embodiment of a pressure system employing dual diaphragms according to embodiments of the present invention.

FIG. 13 is a block diagram of a data processing system according to embodiments of the present invention.

FIG. 14A is a perspective view of an exemplary 3-D sublimated product according to embodiments of the present invention.

FIG. 14B is a side sectional view of the product shown in FIG. 14A.

FIG. 15 is a top perspective view of an exemplary 3-D sublimated product having a registered transferred sublimation image according to embodiments of the present invention.

FIG. 16A is a top perspective view of another exemplary 3-D product having a registered sublimation image according to embodiments of the present invention.

FIG. 16B is a sectional view of the product shown in FIG. 16A.

### DETAILED DESCRIPTION OF EMBODIMENTS OF THE INVENTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the drawings, layers, regions, and/or components may be exaggerated for clarity. In the figures, broken lines indicate optional features unless described otherwise. The method steps are not limited to the order in which they are set forth unless stated otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the term “and/or” includes any and all combinations of one or more of the associated listed items. In addition, spatially relative terms, such as “beneath”, “below”, “lower”, “above”, “upper” and the like, may be used herein for ease of description to describe one feature's relationship to another feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The target sublimation object and/or diaphragm(s) (where used) may be otherwise oriented (rotated 90 degrees or rested on its side or at other orientations) and the spatially relative descriptors used herein interpreted accordingly. Well-known functions or constructions may not be described in detail for brevity.

The terms “ink transfer substrate”, “ink support substrate” and similar terms refer to a substrate material that carries a sublimation image and/or decoration that is adapted to be sublimated onto a target object. The “ink transfer and/or support substrate” can include inks, dyes, and/or other color pigments and/or chemicals thereon that facilitate or define the transferable sublimation decoration. The term “stretch fabric” includes fabrics that elastically stretch by at least about 5% in at least one direction, typically at least about 10%, and in certain embodiments, at least about 30% in a plurality of directions.

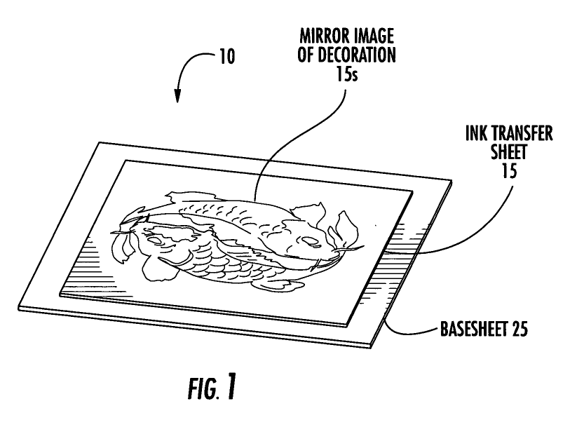

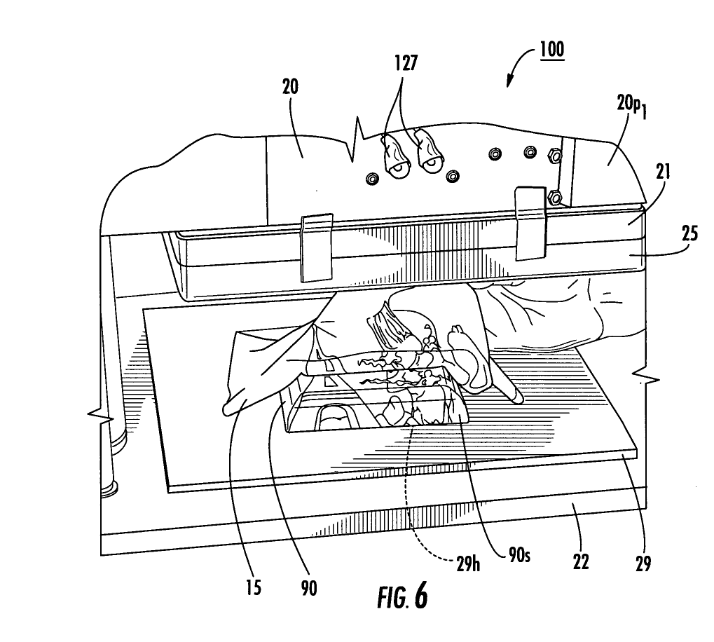

The ink transfer and/or substrate 15 (FIG. 1) can be any suitable flexible material that is thermally stable to at least the desired sublimation heat transfer temperature. The ink transfer substrate 15 has a sublimation image 15s directly printed thereon with the direct-print sublimation image 15s being a substantial mirror image of the end sublimation image 90s as transferred onto the target object (90s, FIG. 6). The ink transfer substrate 15 can be a flexible sheet. The direct-print ink sublimation image 15s can be substantially the same size as the sublimation image 90s (typically the sublimation image 90s is at least about 99% the size of the ink support image 15s). This is in contrast to known conventional two-step fabrics that have at least about a 3% shrinkage, which can be significant over objects having longer lengths and/or widths, such as objects having lengths and/or widths above about 20 inches. The direct-print ink sublimation fabric can also hold increased ink relative to the two-step fabric. The direct print ink support may also have an image that is brighter or has truer colors over indirect images. In some embodiments, the direct print sublimation fabric has a decoration thereon with an increase in color intensity of at least about 20% over a two-step ink support with a sublimation decoration. For example, in one recent test, a two-step print ink support had an integral intensity strength of 100 as compared to a direct print sublimation ink support that had an increased intensity strength of 329, as measured on a spectrometer.

Examples of suitable substrates include, but are not limited to, paper, paper blends, elastomers, polymers, fabrics (natural and/or synthetic), and/or combinations thereof. In some embodiments, the substrate 15 may comprise polymerized cellulose (like RAYON) and/or a polyamide (NYLON), and can include cotton and/or wool as will be discussed further below. In particular embodiments, the substrate 15 can be a non-polyester fabric.

In some embodiments, the substrate 15 is substantially non-stretchable while in other embodiments the substrate 15 is a stretch fabric as described above. In some embodiments, the substrate 15 is chosen so that the knit or weave is sufficiently tight as to reduce the appearance of any surface texture transferred from the substrate configuration onto the end product thus providing a relatively smooth surface with a slick visual appearance and/or without generating any visually detectable fiber pattern thereon. In other embodiments, the substrate 15 is an open weave or knit fabric, such as a relatively coarse fabric, selected to transfer a surface texture as well as the sublimation ink image onto the sublimated end object. For example, the substrate 15 can be configured with a composition and weave or knit that is able to concurrently provide an embossed surface onto the end object with the sublimated image. Thus, the sublimation can be carried out so as to transfer a desired texture as well as a desired sublimated visual image onto the end product. Examples of coarse fabrics include fabrics such as canvas and may comprise a blend of different fibers to form the substrate 15 and/or a substrate 15 with a weave or knit pattern selected to provide the desired end object surface texture.

In some embodiments, the sublimation can apply an increased friction tactile surface along with the sublimated image to simulate a wood grain texture and appearance on the end object. In other embodiments, the end object can have a non-planar texture and the substrate 15 can be a stretch fabric that is able to contact the recesses and peaks of the non-planar surface to evenly transfer the target sublimation image onto the end object.

As shown in FIG. 1, prior to direct printing, the ink transfer substrate 15 can be releasably attached to an underlying base or backing sheet 25. The base sheet 25 may be smaller than or substantially coextensive with the ink transfer sheet 15, but is typically larger as shown in FIG. 1. In certain embodiments, the base sheet 25 may be releasably laminated to the ink transfer sheet 15.

The ink transfer substrate 15 may be configured to stretch when attached to the backing 25 and/or when printing the image 15s. However, the image 15s will be configured so as to provide a “true” sublimation image during sublimation (i.e., to inhibit image distortion during sublimation). In certain embodiments, the ink transfer substrate 15 comprises a stretch fabric that can stretch over a three-dimensional target object during sublimation. In particular embodiments, the ink transfer substrate 15 comprises a stretch fabric that can stretch in a plurality of directions about its length, width and/or diagonally. In certain embodiments, the direct-print ink transfer substrate 15 can be configured with at least two-way elasticity or stretch. The substrate 15 can be selected so that the stretch is generally the same in all directions or to have preferential stretch in a selected direction, e.g., the stretch in a lateral direction can be greater than in the longitudinal direction or vice versa.

In some embodiments, as noted above, the ink transfer substrate 15 can elastically stretch at least about 10% and, in particular embodiments at least about 30% in at least two directions.

The ink transfer substrate 15 may be thin, i.e., less than about 3 mm, typically about 1 mm thick or less, and in certain embodiments, may have a thickness between about 4-12 microns. The substrate 15 may be configured with an absorption capacity selected to provide the desired sublimation image. The ink transfer substrate 15 may have a brushed, flocked and/or pile tactile surface and/or appearance. For example, the yarn may be napped or brushed to provide a primary surface that increases the roughness of the fiber/surface over a natural yarn(s). The ink transfer substrate 15 can be configured to hold a relatively smooth layer(s) of ink to promote the desired sublimation appearance on the target product. The fabric 15 may have a coating layer (s) that facilitates the desired surface texture/characteristic(s).

Some suitable substrates are air-permeable or porous fabrics that include synthetic “stretch” and/or elastomeric fibers. An example of stretch fibers includes synthetic manufactured non-polyester fibers, such as rayon, nylon and/or spandex. The stretch fabric can include other fibers such as cotton and/or wool or other fiber blends. The synthetic stretch fiber can be formed so that the fiber forming substance is a long-chain synthetic polymer. As generally described in certain literature, it is believed that spandex typically comprises at least about 85% of a segmented-polyurethane. According to certain prior art sources, the polymer chain is a segmented block copolymer containing long, randomly coiled, liquid, soft segments that move to a more linear, lower entropy, structure. Generally stated, the segments act as “virtual cross-links” that tie all the polymer chains together into an infinite network. This network prevents the polymer chains from slipping past each other and taking on a permanent set or draw. When the stretching force is removed, the linear, low entropy, soft segments move back to the preferred randomly coiled, higher entropy state, causing the fiber to recover to its original shape and length. This segmented block copolymer is allegedly formed in a multi-step proprietary process. It is extruded into a fiber as a monofilament thread line or, for most products, into a multiplicity of fine filaments that are coalesced shortly after they are formed into a single thread line.

Some synthetic stretch fibers can be stretched repeatedly and still recover to very near original length and shape and can have a stronger, more durable and higher retractive force than rubber while also being generally lightweight, soft, smooth, and/or supple. The stretch fiber can be resistant to deterioration by oils, and when fabrics containing synthetic stretch fibers are sewn, the needle causes little or no damage from “needle cutting” compared to the older types of elastic materials.

Exemplary synthetic stretch fibers are typically available in fiber diameters ranging from about 10 denier to 2500 denier.

LYCRA® is an example of a spandex stretch fiber. Other stretch fibers may also be suitable. Examples include, but are not limited to, fibers presently classified in the polyester textile label classification of the U.S. Federal Trade Commission, under which a new subclass of “elasterell-p” has been proposed as it is described as a stretch fiber which is an inherently elastic, bicomponent textile fiber consisting of two substantially different forms of polyester fibers, DuPont's version of this fiber is referred to as “T400.”

The ink transfer substrate 15 may be formed of fabric having one or more blends of stretch fibers such as nylon, spandex and/or LYCRA®. The one or more stretch fibers can be blended with host or supplemental fibers that may also be synthetic or natural fibers. Thus, selected ones or blends of stretch fibers can include and/or be combined with other natural or synthetic fibers such as cotton, wool, silk, RAYONS, and the like.

One fabric that may be suitable to be a direct-print ink support substrate 15 can comprise a non-polyester material such as nylon and/or RAYON. In some embodiments, the ink support substrate 15 comprises a plurality of fibers including at least one of nylon, RAYON and/or spandex as well as a supplemental fiber (which on its own may not provide desired stretch capability) such as cotton, wool, and the like.

The sublimation image 15s may be printed onto a selected primary surface of the ink transfer substrate 15 according to conventional direct-print processes known to those of skill in the art.

TABLE 1
EXEMPLARY INK SUPPORT SUBSTRATE COMPOSITIONS

| | |
|---|---|
| 0-100% | NYLON |
| 0-100% | RAYON |
| STRETCH | At least about |
| | 10% |

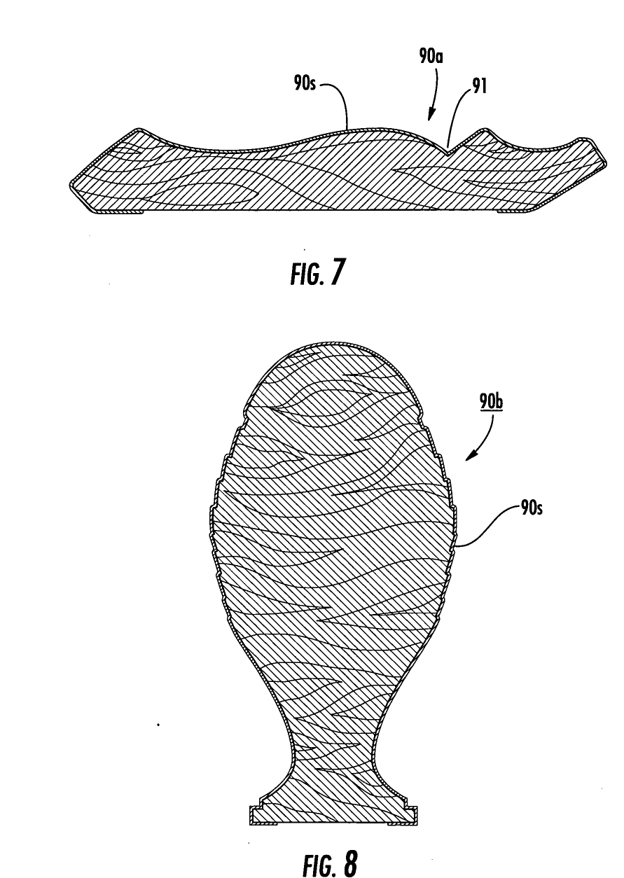

The reference number 90 generally refers to target objects, but for clarity, the target objects identified in FIGS. 6-8 and FIGS. 14A-16A are referenced as element 90 with a letter suffix (such as “a”, “b”, “c” and the like) to denote different target objects. Surfaces of the target object 90 that are to be sublimated may be prepared with a (typically clear or white) polymeric coating as is well known to those of skill in the art. The ink transfer substrate 15 can be configured to apply a continuous over-the-edge design to the target object 90 as shown in FIGS. 7, 8, 14B and 16B. By forcing the sublimation image 15s intimately against the target object 90 while applying heat, the ink transfer image 15s is sublimated and transferred onto the target object 90s.

In some embodiments of the present invention, the sublimation is carried out to generate precision-registration of a complex decoration on a three-dimensionally contoured surface(s) that can include irregular interior surface indentation/patterns, such as relatively deep contours or grooves, sharp angles, recess and projection patterns, and the like. The sublimation may be carried out to simulate real-wood grain, distressed wood, or marble/granite on a lower cost substrate and/or to apply a simulated “hand-painted” decoration. The target object substrate can be wood (including particle board and/or pressed-or laminated wood), glass, metal, stone, ceramics, polymers (with suitable temperature resistance and structural rigidity) or any other suitable material as well as combinations of same.

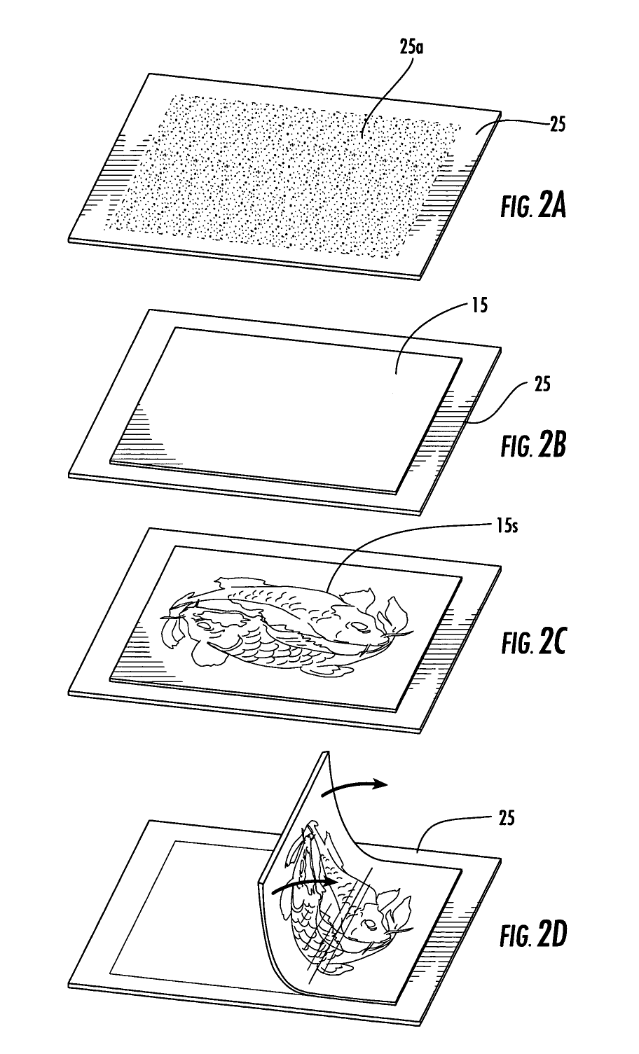

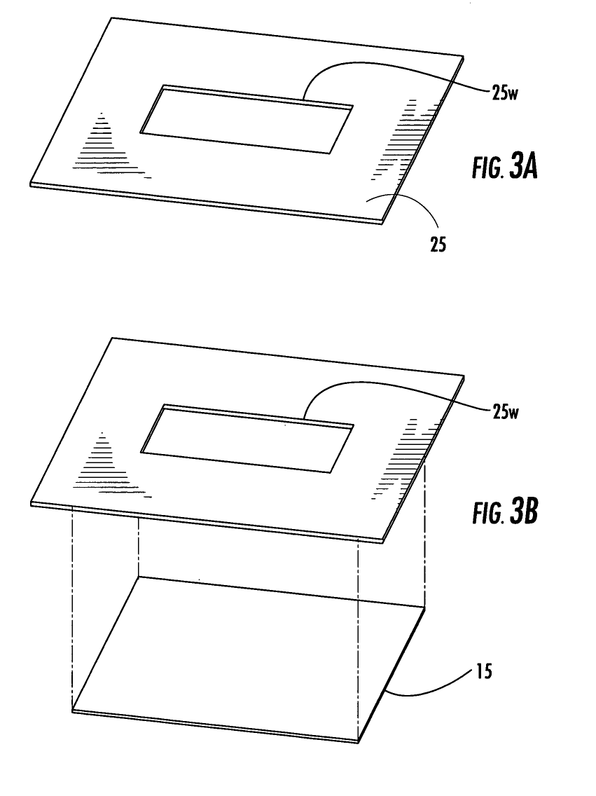

FIGS. 2A-2D illustrate a series of operations that can be used to fabricate a direct-print ink transfer substrate 15 according to embodiments of the present invention. FIG. 2A illustrates the backing sheet 25 which can be preformed with an adhesive 25a thereon, typically applied generally evenly over a major portion of a selected primary surface of the backing substrate or backing sheet 25. The adhesive is selected so as to be able to hold the ink transfer substrate 15 in position on the backing sheet 25 while allowing the backing 25 and/or the ink transfer sheet 15 to be peeled and released after printing. FIG. 2B illustrates the ink transfer sheet 15 attached to the backing 25 and FIG. 2C illustrates the direct-printing operation completed to impart the sublimable image 15s thereon. After direct printing, as shown in FIG. 2D, the backing sheet 25 can be removed and the direct-print ink transfer sheet 15 is ready for use in a sublimation procedure. As noted above, the direct-print sheet 15 can provide a sublimation image on the target object that is substantially the same size, typically at least about 99%, and, in certain embodiments, at least about 99.5% the size of the image on the sheet 15. The image 15s can be a continuous image of at least about 10 inches long and/or wide, and in some embodiments at least about 20 inches long and/or wide. In some embodiments, the image may be a generally continuous image and the ink substrate 15 may have a printable area of about 26⅞″ by about 39″ or about 41½″ by about 59″.

FIG. 3A illustrates that the backing layer 25 need not be a continuous sheet. In the embodiment shown, a window 25w is formed in the backing sheet 25. The backing 25 may still be structurally sufficient to hold the ink transfer substrate 15 during printing. FIG. 3B illustrates the ink transfer substrate 15 aligned over the base sheet 25.

The backing 25 can be a laminated sheet or a single ply sheet, and typically is a cellulose-based (paper-like) material with or without reinforcing fibers such as glass or cotton. The backing 25 may be configured to be substantially smooth so as to inhibit surface imperfections on the ink transfer sheet 15 as the printing is formed onto the overlying ink transfer substrate 15. The backing sheet 25 may be thin, i.e., have a thickness of between about 0.002-0.040 inches (2-40 thousandths). The backing sheet 25 will typically have less stretch and increased structural rigidity than the ink transfer sheet 15. The backing sheet 25 may be a single ply of material or a multi-ply material.

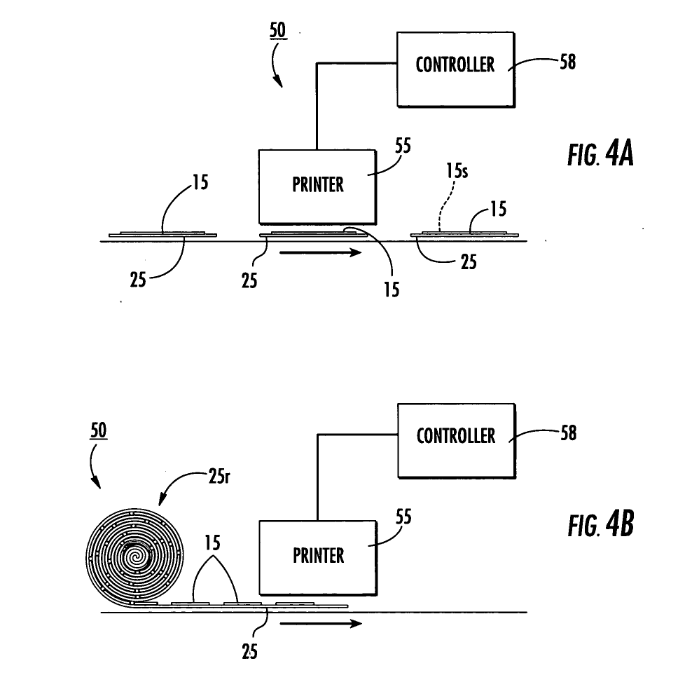

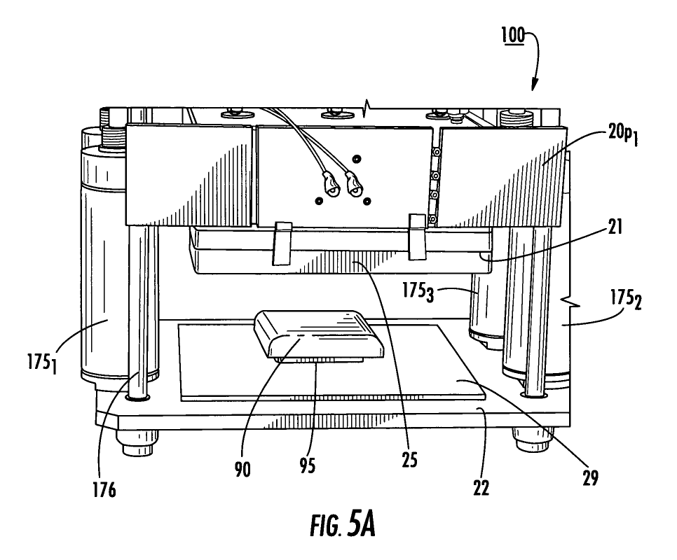

FIG. 4A illustrates a direct-print system 50 that is configured to imprint the ink transfer substrate 15 with a mirror image of the ultimate sublimation image 90s (FIG. 6) that will be transferred to the end product 90. As shown, the system 50 includes a printer 55 and controller 58. Integrated backing and ink transfer sheets 10 can be hand fed serially to the printer or automated to travel via a conveyor or other drive means. FIG. 4B illustrates that the backing 25 may be a continuous roll 25r of backing material that can support spaced apart ink transfer sheets 15 the roll can be unwound (pulled) to serially present the respective ink transfer sheets 15 for direct printing according to embodiments of the present invention.

The printers 55 can be any suitable printer, such as, but not limited to, those used for (color) offset printing, screen printing, flexo printing, Gravure printing and/or digital printing, as is well known to those of skill in the art.

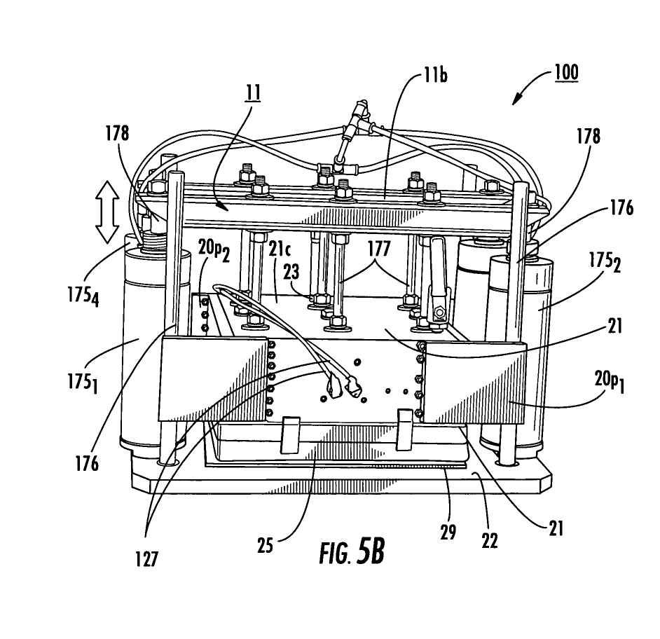

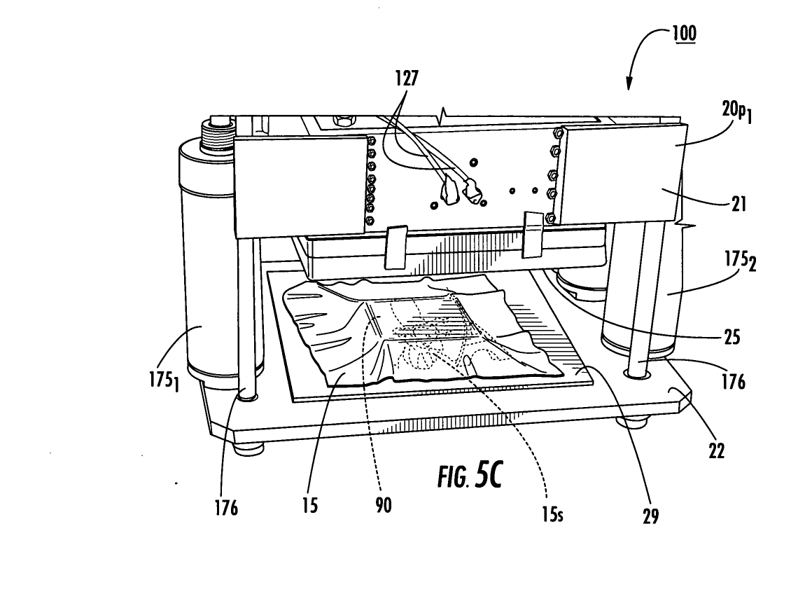

FIGS. 5A-5C illustrate one example of a sublimation system 100 that may be particularly suitable for using direct-print substrates employs a sealed enclosed pressure vessel with at least one internal diaphragm. In operation, fluid is directed into the pressure vessel onto the diaphragm to elastically deform, inflate, press and/or push the diaphragm to mold about the exposed outer surfaces of a target object. The pressure vessel can be used to mold the substrate 15 into grooves, angled or recessed or raised surfaces and/or provide a continuous and/or registered sublimation image that can be transferred “over the edge” and/or onto the non-planar profiles on three dimensional structures.

As shown, the pressure vessel system 100 includes a frame 11 that holds the first and second housing members 21, 22, in alignment. The system 100 includes at least one, and typically (as shown) a plurality of actuation cylinders 175. In the embodiment shown, the system 100 includes two translation actuators 175₁, 175₂, one on each side of the pressure chamber that cooperate to raise and lower the first housing member 21 with diaphragm 25. In the embodiment shown, the second housing member 22 is stationary. The actuators 175₁, 175₂ can be air or hydraulic actuators and are typically controlled by the control module 50M (FIG. 9) and/or controller 50 to automatically separate the first and second members 21, 22 when the pressure reaches a suitable level after sublimation and to automatically close the two members 21, 22, together to initiate operation once a target object is placed therein (typically represented by an operator depressing a “start” input key or button).

As shown in FIG. 5A, the frame 11 includes a laterally extending bracket 11b that spans the width and/or length of the first member 21. The bracket 11b is attached to the ceiling 21c of the first member 21 via (threaded) attachment members 177. The bracket 11b is also attached to rods 178, of at least one (shown as two) translation actuators 175₁, 175₂ and is configured to move up and down as directed by movement of the actuator rods 178, as is the first housing member 21. The frame 11 includes guide rods 176 that are affixed to the base or second member 22 and guide/stabilize the first member 21 as it moves up and down about a predetermined travel path in response to the movement of the actuators 175₁, 175₂. The first member 21 can include a forward and rearward plate 20p₁, 20p₂, respectively, that reside on the outside of the guide rods 176 to stabilize and/or hold the first member 21 in alignment over the second member 22 as it travels up and down. Other alignment and/or stabilizing means can be used as known to those of skill in the art. The front lever 227 shown can operate a release valve for a pressure vent means. Leads 127 can provide the electrical connection for components of the system 100. For example, one (or more) lead 127 can power an internal heater and another lead 127 can be connected to a temperature sensor in the cavity 20c.

FIG. 9 illustrates a sublimation system 100 with a pressure vessel 20, a heat source 30, and a fluid source 40. In the embodiment shown, the pressure vessel 20 includes an elastically deformable (flexible) diaphragm 35 that resides above the target object 90. The system 100 is configured to operate with positive pressure to push the diaphragm against a target object 90. It will be appreciated that if the orientation of the pressure vessel 20 is altered from that shown, the diaphragm 35 may be positioned to the side or below the object (not shown) rather than above. The diaphragm 35 is formed of an elastically deformable material, typically an elastomeric material comprising silicone, rubber, or another heat-tolerant and resilient material that is able to elastically deform over a plurality of sublimation operations, typically at least about 10 operations at an operating pressure of at least about 5 psi, and typically above about 20 psi. The diaphragm 35 may also be substantially impermeable to the fluid used to increase the pressure in the chamber 20c. The diaphragm 35 may have a thickness of between about 0.005-0.030 inches. The area of the diaphragm 35 may vary, depending on the size of the pressure chamber 20. A front lever can operate a release valve for a pressure vent means. Leads 127 can provide the electrical connection for components of the system 100.

Referring to FIGS. 6 and 9, the chamber 20c can include a high temperature shutoff or cutout that can interrupt operation upon detection of a high temperature event. For example, a heat and/or temperature sensor 27 (FIG. 9) can be positioned in the chamber 20c to detect the temperature in the chamber 20c, on the diaphragm 25, on the base 95 and/or proximate the target object substrate 90 (while not inhibiting contact with ink transfer sheet). In some embodiments, a temperature sensor 29h (FIG. 6) is positioned on top of the gasket or insulator surface 29 and contact the substrate 90 directly. In other embodiments, a temperature sensor 29h can be placed on the base 95 so as to contact the target object 90. The temperature data can be automatically monitored by the controller 50 (FIG. 9) and the power to the heating elements interrupted if an over temperature condition is detected.

Although shown as sublimating a single object 90 during a single sublimation operation, multiple objects (of the same or different shapes) may also be sublimated concurrently. A single ink transfer sheet 15 may be used to cover all of the objects 90 or separate/discrete ink transfer sheets 15 can be used for each object (not shown). The concurrent sublimation of multiple target objects 90 can be carried out by spacing the objects 90 apart in the chamber 20c appropriately and/or sizing the chamber 20c to allow the diaphragm 35 sufficient volume/area to push down (press) against and generally envelop each exposed surface of the object (normally tenting about the object even prior to elevating the pressure in the chamber), without positioning adjacent objects so as to impede the desired three-dimensional diaphragm 35 coverage thereof. In certain embodiments, the target objects 90 are held away from the perimeter or sidewalls of the chamber 20c, typically at a border distance of at least about 1-3 inches, so that the diaphragm 35 has sufficient elastic deformation capability to mold against the target object 90.

As shown in FIG. 9, the diaphragm 35 is typically held in tension across the cavity 20c and attached to a perimeter of the vessel 20 (shown as defined by four upwardly extending sidewalls) of the pressure vessel 20 so as to sealably separate or divide the cavity 20c to form at least one fluidly isolated compartment therein. In operation, fluid from the fluid source 40 is directed into the pressure cavity 20c to increase the pressure inside the pressure vessel 20 and press against one primary surface of the diaphragm 25 to elastically deform the diaphragm 35 in response thereto.

The pressure vessel 20 can be configured to withstand at least about 100 psi, but operates at a lower elevated pressure, such as above 5 psi, typically above 1 atm, more typically between about 20-50 psi, and most typically between about 20-25 psi. The housing of the pressure vessel 20 may be metallic. The pressure vessel 10 can include first and second rigid housing members 21, 22, respectively, that releasably attach together and define the enclosed pressure chamber 10 when sealed together. As shown in FIG. 9, the system 100 also includes a heater 30 that is in communication with the pressure chamber 20c so as to elevate the temperature therein during the sublimation process. The heater 30 may be an external heater, may be integrated into the pressure vessel housing itself, and/or may preheat the fluid to apply the desired sublimation temperatures to the object 90. Combinations of these configurations may also be used. The system 100 may be configured to elevate the temperature in the chamber 20c to at least 200° F., typically between about 300-500° F., but higher temperatures or lower temperatures may be used in some embodiments. In particular embodiments, the temperature in the chamber 20c is raised to at least about 350° F. for a desired time, typically at least one minute with the pressure elevated to at least about 20 psi. In some embodiments, the pressure is elevated to at least about 25 psi, while the temperature is at or above about 350° F. for at least about 3 minutes to sublimate the object 90, and more typically, the pressure in the chamber 20c is at least about 25 psi while the temperature in the chamber 20c is at least about 350° F. for about 5 minutes. Longer or shorter times may be used in certain embodiments. The temperature may be elevated before, during and/or after the pressurization.

In any event, in operation, the temperature in the chamber 20c is elevated to a desired temperature, and fluid is directed into the pressure chamber 20c to apply pressure to a selected primary surface of the diaphragm 35 to urge the diaphragm 35 to travel in a predetermined direction so as to be in intimate contact with the target object 90 positioned in the pressure chamber 20, thereby applying pressure and temperature sufficient to carry out transfer of a sublimation decoration onto/into the target object 90.

An example of another sublimation apparatus is described in U.S. Pat. No. 5,308,426, which proposes a vacuum and heated space to cause transfer of the decoration to all the surfaces of the object. U.S. Pat. Nos. 5,798,017 and 5,893,964 propose a vacuum apparatus with opposing elastic membranes or a sealed pouch that surround the target object and are capable of deforming in all directions. U.S. Pat. No. 6,126,699 proposes transferring a sublimation decal to a wooden article using a press having a heated platen at a temperature of around 200° F. and a pressure of between about 40-50 psi to print diverse dyes on the wooden article. The contents of the above patents are hereby incorporated by reference as if recited in full herein.

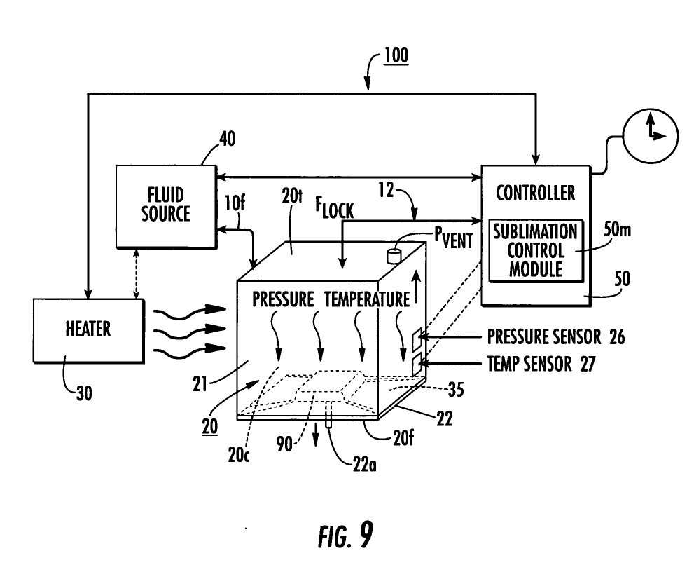

FIG. 10A illustrates that the target object 90 can be held on the gasket 29 (or directly on the floor 20f) with the diaphragm 35 molded (via pressure) thereover. The floor 20f can include pressure release vent apertures 22a that allow trapped air to be vented when the chamber 20c is closed. FIG. 10B illustrates that the target object 90 may be placed on a base or platform member 95 to raise the target object 90 a desired distance “D” above the floor 20f. In some embodiments, the base member 95 is sized and configured to be smaller than the adjacent portion of the target object 90, i.e., to have a smaller area than the bottom of the target object 90. The base member 95 can be configured to allow the diaphragm 35 to mold about lower portions of the target object 90 that may otherwise be blocked by the floor 20f. Different shaped objects 90 may employ different shaped bases 95. The base 95 may be attached to the floor 20f or just reside thereon. In particular embodiments, the base 95 is made of a thermal insulating material, such as silica (formulated similarly to a dropped or pre-fab ceiling tile), ceramic, foam, elastomer, rubber, wood, resin, fiberglass, and the like, including combinations of the above.

In some embodiments, the base 95 may be a dowel, rod, pin and/or bracket or other suitable mounting means that is attachable to the object or insertable into a channel or receiving means formed in the object (not shown). For example, the base 95 can be configured as a generally vertically oriented pin or rod sized to enter a mating segment formed in the object 90 to hold the object 90 (such as a finial or upwardly extending member) generally upright in the chamber 20c. In another example, a base 95 can be configured to rise from the floor a distance and generally laterally extend a distance inside the chamber 20c as a bar, rod, or the like, to enter a mating segment in the object 90 to hold the object 90 (such as a chair spindle) in a generally horizontal orientation.

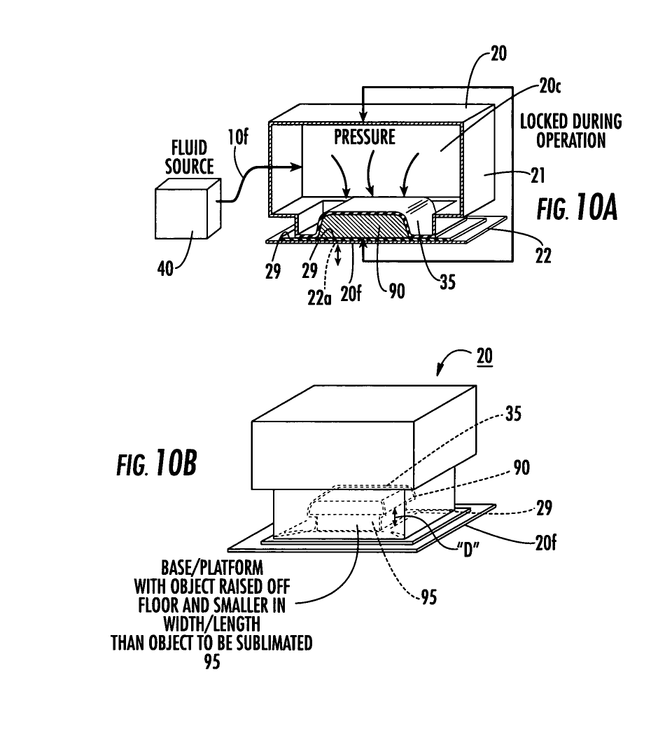

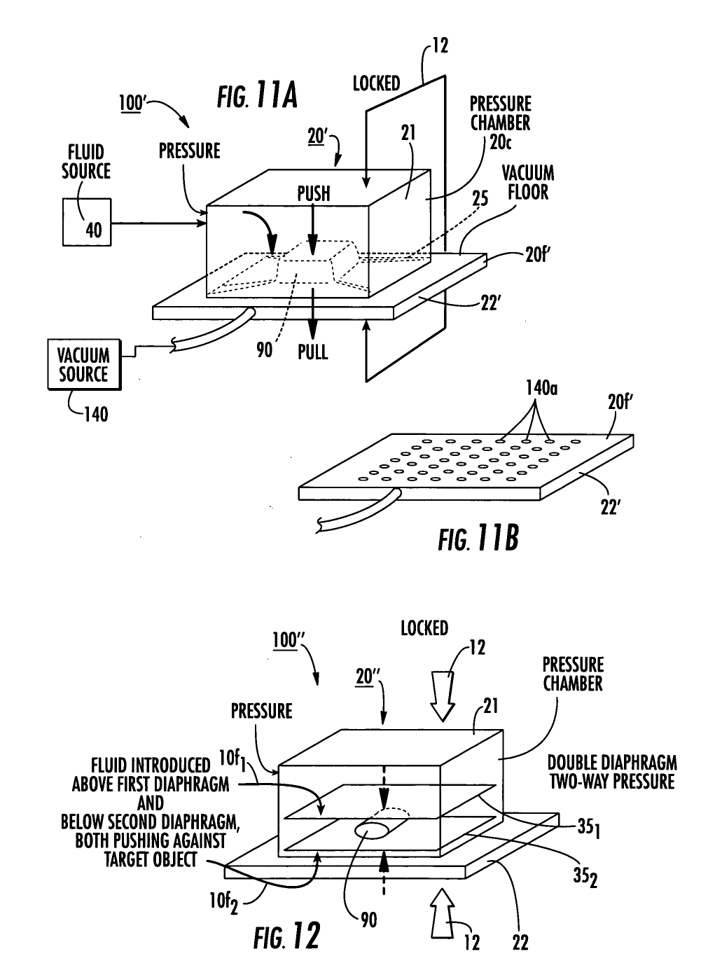

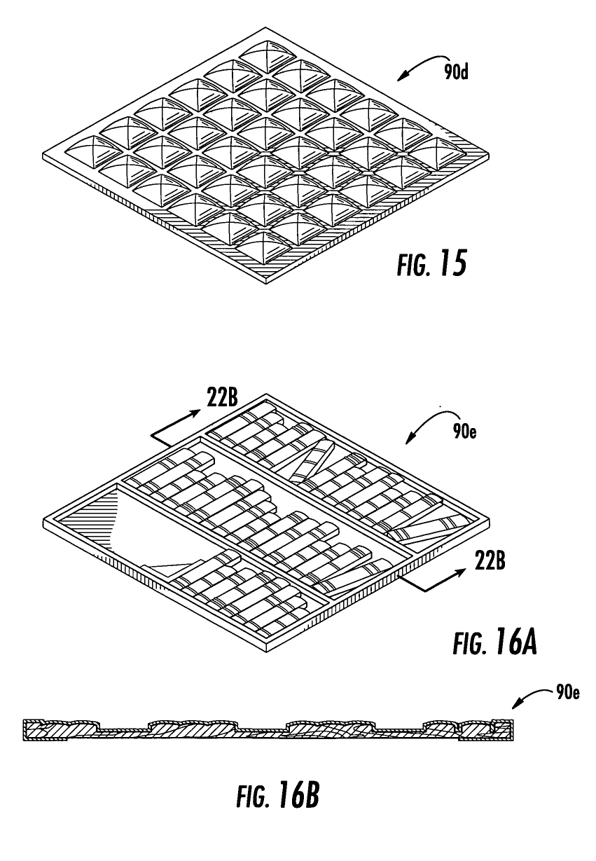

FIG. 11A illustrates yet another embodiment of a pressure vessel system 100′ that employs a pressure vessel 20′. In this embodiment, the floor 20f′ of the pressure vessel 20′ has a plurality of apertures 140a (FIG. 15B) that are in communication with a vacuum source 140. In operation, the diaphragm 35 is both pushed from the top (as before) and pulled from the bottom by the vacuum floor 20f′ (as shown by the arrows located above and below the diaphragm 35) to mold to surfaces of the object 90.

FIG. 11B illustrates yet another embodiment of a pressure vessel system 100″. In this embodiment, the pressure vessel 20″ includes two spaced apart diaphragms 35₁, 35₂ with the object 90 held therebetween. The system 100″ can have two flow paths 10f₁, 10f₂ to introduce fluid both above the first diaphragm 35₁, thereby pushing that diaphragm 35₁ down, and below the second diaphragm 35₂ thereby pushing that diaphragm 35₂ up. The first diaphragm 25₁ may be held in the first member 21 and the second 35₂ may be held in the second housing member 22. Other configurations may be used, such as additional intermediate sealably stackable housing members (not shown), that can be configured to align the diaphragms 35₁, 35₂ and seal the pressure vessel 20″.

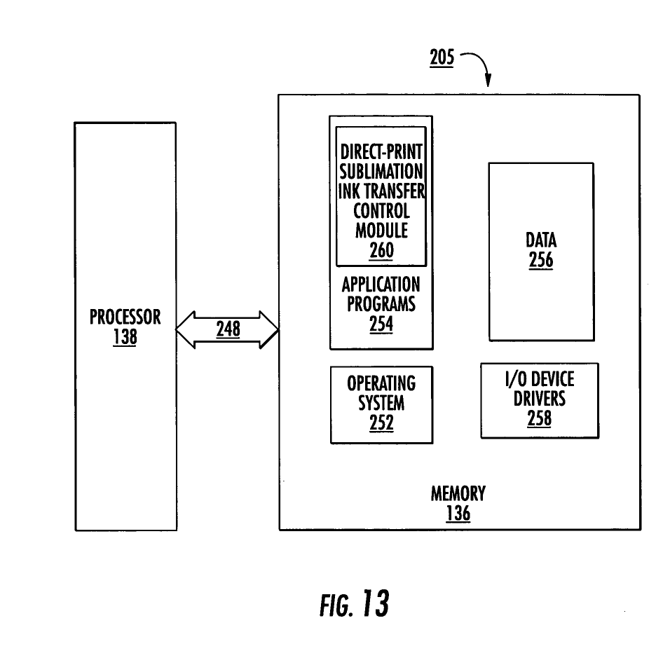

FIG. 13 is a block diagram of an exemplary embodiment of a data processing system 205 that illustrates systems, methods, and computer program products in accordance with embodiments of the present invention. The processor 138 communicates with the memory 136 via an address/data bus 248. The processor 138 can be any commercially available or custom microprocessor. The memory 136 is representative of the overall hierarchy of memory devices containing the software and data used to implement the functionality of the data processing system 205. The memory 136 can include, but is not limited to, the following types of devices: cache, ROM, PROM, EPROM, EEPROM, flash memory, SRAM, and DRAM.

As shown in FIG. 13, the memory 136 may include several categories of software and data used in the data processing system 205: the operating system 252; the application programs 254; the input/output (I/O) device drivers 258; the Printer Direct-Print Control Module 260 (which may be used in the controller 58 in FIGS. 4A and/or 4B) for directing printing onto the direct-print sublimation ink support fabric; and the data 256.

The data 256 may include a look-up chart of different ink transfer substrate materials, different sublimation inks, different sublimation images corresponding to target objects and/or used to define any production-specific operational parameters associated therewith corresponding to particular or target ink transfer substrates, images, and/or products for one or more producers.

As will be appreciated by those of skill in the art, the operating system 252 may be any operating system suitable for use with a data processing system, such as OS/2, AIX, DOS, OS/390 or System390 from International Business Machines Corporation, Armonk, N.Y., Windows CE, Windows NT, Windows95, Windows98 or Windows2000 from Microsoft Corporation, Redmond, Wash., Unix or Linux or FreeBSD, Palm OS from Palm, Inc., Mac OS from Apple Computer, LabView, or proprietary operating systems. The I/O device drivers 258 typically include software routines accessed through the operating system 252 by the application programs 254 to communicate with devices such as I/O data port(s), data storage 256 and certain memory components. The application programs 254 are illustrative of the programs that implement the various features of the data processing system 205 and preferably include at least one application which supports operations according to embodiments of the present invention. Finally, the data 256 represents the static and dynamic data used by the application programs 254, the operating system 252, the I/O device drivers 258, and other software programs that may reside in the memory 136.

While the present invention is illustrated, for example, with reference to the Module 260 being an application program in FIG. 13, as will be appreciated by those of skill in the art, other configurations may also be utilized while still benefiting from the teachings of the present invention. For example, the Module 260 may also be incorporated into the operating system 252, the I/O device drivers 258 or other such logical division of the data processing system 205. Thus, the present invention should not be construed as limited to the configuration of FIG. 13 which is intended to encompass any configuration capable of carrying out the operations described herein.

The I/O data port can be used to transfer information between the data processing system 205 and the printing head or another computer system or a network (e.g., the Internet) or to other devices controlled by the processor. These components may be conventional components such as those used in many conventional data processing systems, which may be configured in accordance with the present invention to operate as described herein.

While described above with respect to particular divisions of programs, functions and memories, the present invention should not be construed as limited to such logical divisions. Thus, the present invention should not be construed as limited to the configurations of FIG. 13 but is intended to encompass any configuration capable of carrying out the operations described herein.

The operations and sequence of events can be controlled by a programmable logic controller (PLC). The data processor can be integrated in the PLC. The sublimation process can be initiated by or the system activated using an operator input using a Human Machine Interface to communicate with the controller as is well known to those of skill in the art. In certain embodiments, a computer program product or data processor can include computer program code that can automatically perform, monitor and/or direct one or more of the following actions: operate the printing head, select the type, color and/or quantity of inks or dyes, select what image to apply (direct print).

The flowcharts and block diagrams of certain of the figures herein illustrate the architecture, functionality, and operation of possible implementations of selective implementation of sublimation operations according to the present invention. In this regard, each block in the flow charts or block diagrams represents a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved.

Embodiments of the present invention allow for precision or engineered placement of sublimation applied designs, images and/or decorations that can be registered to contours or surfaces on the target object. The transfer design can be a complex pattern for three-dimensional items with grooves, sharp contours, edges and the like. In certain embodiments, the sublimation image and/or decoration can be transferred reliably to be within at least about 1/32nd of an inch from a registered placement of the design on the object.

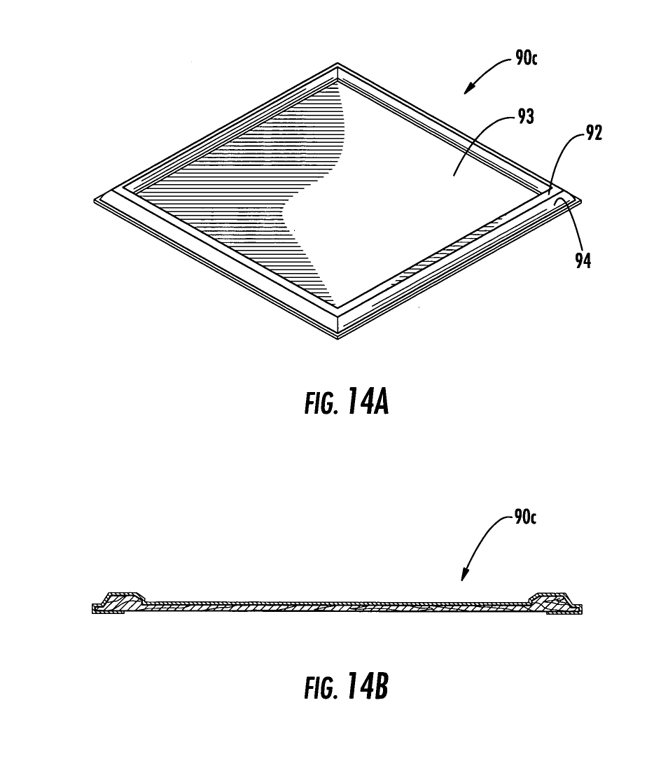

FIGS. 14A and 14B illustrate a frame-like object 90c having a raised perimeter portion 92 that surrounds an inner recessed center region 93. The object 90c can also have an outer edge portion 94 that surrounds the raised portion 92. The sublimation can be carried out to apply a continuous image (using a single ink transfer sheet) over each of the three regions, 92, 93, 94. The image may be registered to the object so that the center and raised regions have a different predetermined image. For example, the raised region 92 may have a simulated “frame” (wood-like, or other appearance) while the recessed center may have art or an image aligned thereon. The object may be used as a panel in a piece of furniture or as a tabletop, and the like.

FIG. 15 illustrates that the object 90d can have a contour that simulates a predetermined quilt configuration with squares or other shapes, generally forming an intricate pattern of smaller simulated-fabric like segments that are arranged in a repeating pattern to provide an overall quilt image, as with sewn quilts. The quilted contour object has a plurality of different contours and a registered sublimation image formed thereon.

FIGS. 16A and 16B illustrate that the object 90e can have a surface contoured to simulate a bookshelf with books thereon. As before, the book and shelf image can be sublimated thereon, registered to the corresponding contours of the object 90e. As shown, the object 90e can be formed with a plurality of irregularly spaced grooves and contours simulating the general shape of different books placed on a bookshelf. Similarly, the object may be contoured to represent a roll-top type furniture desk top/door contour with the wood simulation sublimation image applied thereon so that the image is registered over the grooves (not shown)

In some embodiments of the present invention, the ink transfer image 15s can be configured to generate precision-registration of a complex decoration on a three-dimensionally contoured surface(s) that can include relatively deep contours or grooves, sharp angles, recess and projection patterns, and the like. The sublimation may be carried out to simulate “real” wood grain (such as cherry, knotty pine, oak, and the like), distressed wood (such as a crackled, aged or antique look), veneer, simulated stone such as granite, or marble and laminates, by applying the simulated sublimated image appearance onto a lower cost substrate. Other embodiments can be used to apply a simulated “hand-painted” decoration or decal using the sublimation techniques provided by embodiments of the invention.

Examples of target objects include, but are not limited to furniture objects, such as bedposts, tables including table-tops, furniture drawer panels, cabinet doors, major appliance doors, sofa or chair arm pieces, sofa or chair backs, legs, and spindles, lamp bases, doors, bed frame members, bed knobs, door knobs, drawer knobs and handle grips, finials (such as for curtain rods or to attach lampshades), glass objects (to create a faux beveled edge glass look, a simulated stained or antique-green glass or frosted glass, and the like), flooring, trim and moldings such as base board, floor board, corner piece molding, crown molding, curtain rods, rails, patio furniture, (interior) car trim, and the like. Other objects include soda bottles, coffee cups, pens, pencils, promotional items, cell phone bodies (flips), and the like. Of course, flat or planar objects may also be sublimated using certain embodiments of the present invention.

Certain target objects have distinct surface and/or edge contours, including internal sharp edges or relatively deep grooves, mitered or router channels, or other wells or recesses. Some may be located on the outer edge portions while others may be located internally. Examples of contour patterns include bull nose, beveled, multiple different contour shapes (e.g., raised panel and grooves) and the like. The image can be sublimated onto the complex shapes to a relatively tight-tolerance registered position as noted above. For example, a first raised panel print decoration on the raised surface with a second recessed background decoration on an adjacent recessed surface using a continuous transfer sheet and a single sublimation operation/process may be employed.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses, where used, are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of fabricating a direct-transfer sublimation substrate, comprising:
directly printing a sublimation image that is a substantial mirror image representation of a desired end sublimation image onto a primary surface of a selected ink transfer fabric that is releasably attached to a backing material; then
separating the ink transfer fabric from the backing material to thereby provide a direct-print sublimation image for transfer to a target object during sublimation.

2. A method according to claim 1, wherein the fabric is a stretch fabric.

3. A method according to claim 1, wherein the stretch fabric comprises RAYON.

4. A method according to claim 2, wherein the stretch fabric comprises nylon.

5. A method according to claim 2, wherein the backing material has an elasticity that is less than that of the first material, and wherein the fabric has an absorption capability sufficient to hold sublimation ink in a desired quantity and pattern thereon.

6. A method according to claim 1, wherein the fabric is brushed and/or napped.

7. A method according to claim 1, wherein the fabric is knitted or woven.

8. A method according to claim 2, wherein the fabric is figured to elastically stretch by at least 10% in at least two directions.

9. A method according to claim 1, wherein the fabric is about 1 mm thick or less.

10. A method according to claim 1, wherein the backing material comprises paper that is laminated to the direct print fabric substrate prior to the printing step.

11. A method according to claim 1, wherein the ink transfer substrate is a thin sheet of fabric and the backing material is a thin sheet of a different material that has a larger area and less elasticity than the fabric sheet, and wherein the end sublimation image is at least about 99% the size of the image on the ink transfer fabric, and wherein the sublimation image is greater than about 10 inches long and/or wide.

12. A method according to claim 1, wherein the backing material is a roll stock of sheet material, and wherein a plurality of spaced apart first ink transfer substrate sheets are releaseably attached thereto, the method further comprising unrolling the backing material sheet stock to serially present the ink transfer substrates to a printing head and serially printing the ink substrate sheets.

13. A method according to claim 1, wherein the printing step is carried out using 4-color offset printing and comprises imprinting a mirror image of the desired ultimate sublimation image on the selected primary surface of the ink transfer substrate.

14. A method according to claim 1, further comprising applying adhesive to a selected primary surface of the backing layer, pressing a selected primary surface of the ink transfer fabric against the adhesive on the backing layer prior to directly printing the sublimation ink image onto an exposed primary surface of the ink transfer fabric, and wherein, after the directly printing step, the separating step comprises pulling the ink transfer substrate off the backing layer.

15. A method according to claim 14, wherein, after the separating step, the method further comprises stretching the direct-print fabric with the sublimation ink image thereon over a three dimensional target object and sublimating the image onto the three dimensional object with the direct-print fabric held stretched in intimate contact therewith to thereby transfer the sublimation image onto the object.

16. A method for sublimation printing a target object, comprising:
placing a direct-print ink transfer fabric with a mirror image of the desired end sublimation image imprinted thereon over a target object so that the ink transfer fabric is in intimate contact therewith, with the sublimation image contacting the object; and
sublimating the target object to thereby transfer the sublimation image on the direct-print ink transfer fabric to the target object.

17. A method according to claim 16, wherein the direct-print ink transfer substrate is a stretch fabric that is about 0.040 inches (about 1.0 mm) or less thick.

18. A method according to claim 17, wherein the stretch fabric is configured to stretch at least about 10% in at least two directions.

19. A method according to claim 16, wherein the direct-print ink transfer fabric comprises RAYON.

20. A method according to claim 16, wherein the direct-print ink transfer fabric comprises nylon.

21. A method according to claim 17, wherein the stretch fabric is a single ply of material.

22. A method according to claim 17, wherein the stretch fabric comprises multiple plies.

23. A method according to claim 16, wherein, during sublimation, the direct-print ink transfer fabric is in intimate contact with the outer surface of the object and continuously covers the outer surface thereof including grooved channels with sharp edges and/or deep channels to thereby provide a substantially continuous sublimation decoration.

24. A method according to claim 16, wherein the ink transfer fabric is configured with a sufficiently open weave or knit, and wherein the method further comprises applying a surface texture to the object during sublimation using the ink transfer fabric.

25. An apparatus for directly printing a sublimation image on a direct-print ink transfer substrate, comprising:
an offset printer;
a controller in communication with the printer; and
a direct-print ink support textile fabric positioned in communication with the printer, the printer configured to print a mirror image of an end sublimation image onto the ink support textile fabric, the direct-print mirror image having a size that is at least about 99% the size of the end sublimation image.

26. An apparatus according to claim 25, wherein the controller comprises computer program code configured to automatically direct the printer to output a plurality of different colors in a predetermined amount and pattern to generate a color image in a mirror image of a selected one of a library of end sublimation images.

27. An apparatus according to claim 25, wherein the direct-print ink transfer fabric is a stretch fabric about 0.040 inches (about 1.0 mm) or less thick.

28. An apparatus according to claim 27, wherein the direct-print ink transfer fabric comprises RAYON.

29. An apparatus according to claim 27, wherein the direct-print ink transfer fabric comprises nylon.

30. A direct-print ink support sublimation substrate comprising an elastic textile stretch fabric having a direct-print sublimation mirror image representation of a desired end sublimation image thereon, the direct-print sublimation image having a size that is least about 99% that of the end sublimation image.

31. A direct-print ink support according to claim 30, in combination with a backing material releasably attached thereto, wherein the image on the direct print ink support fabric is at least 10 inches long and/or wide.

32. A direct-print ink support according to claim 30, wherein the image on the direct print ink support fabric is at least about 26 inches long and/or wide.

33. A direct-print ink support according to claim 30, wherein the elastic textile non-polyester stretch fabric comprises RAYON.

34. A direct-print ink support according to claim 30, wherein the elastic textile non-polyester stretch fabric comprises nylon.

35. A three-dimensional product having a sublimated image thereon produced by the method of claim 16.
